(19) United States
(12) Patent Application Publication
(10) Pub. No.: US 2025/0154970 A1
(43) Pub. Date: May 15, 2025

(54) STRUCTURE OF INFLOW PORTION OF RESERVE TANK

(71) Applicant: TOYOTA JIDOSHA KABUSHIKI KAISHA, Toyota-shi (JP)

(72) Inventor: Genichi KOARAI, Kakamigahara-shi (JP)

(73) Assignee: TOYOTA JIDOSHA KABUSHIKI KAISHA, Toyota-shi (JP)

(21) Appl. No.: 18/785,491

(22) Filed: Jul. 26, 2024

(30) Foreign Application Priority Data
Nov. 10, 2023 (JP) 2023-191979

(51) Int. Cl. F15D 1/02

(52) U.S. Cl. CPC F15D 1/025

(57) ABSTRACT

In the structure of the inflow portion of the reserve tank provided in the cooling liquid circulation circuit, in a case where the inflow portion has a side closer to the reserve tank body as one end side and a side farther from the reserve tank body as the other end side, the flow passage area on the one end side is made larger than the flow passage area on the other end side in the inflow portion. The flow path shape inside the inflow portion has a tapered shape in which the flow path area gradually increases from the other end side toward the one end side.

### CROSS-REFERENCE TO RELATED APPLICATION

This application claims priority to Japanese Patent Application No. 2023-191979 filed on Nov. 10, 2023, incorporated herein by reference in its entirety.

### BACKGROUND

### 1. Technical Field

The present disclosure relates to a structure of an inflow portion of a reserve tank provided in a cooling liquid circulation circuit.

### 2. Description of Related Art

Conventionally, as disclosed in Japanese Unexamined Patent Application Publication No. 2022-53938 (JP 2022-53938 A), for example, a vehicle is provided with a cooling liquid circulation circuit that cools a device (heat generating component) that generates heat, and the device is cooled by a cooling liquid that circulates in the cooling liquid circulation circuit. In addition, the cooling liquid circulation circuit is provided with a reserve tank. The reserve tank is used to replenish the cooling liquid circulation circuit with the cooling liquid, and has a function of accommodating a change in the volume of the cooling liquid due to thermal expansion.

When air is mixed into the cooling liquid in the reserve tank, the air may flow out to the cooling liquid circulation circuit, which may cause a deterioration of the cooling efficiency of the device.

In view of this respect, Japanese Unexamined Patent Application Publication No. 2021-169815 (JP 2021-169815 A) and Japanese Unexamined Patent Application Publication No. 2022-149429 (JP 2022-149429 A) have been proposed. JP 2021-169815 A discloses a structure in which a cooling liquid is swirled in a reserve tank, whereby air mixed in the cooling liquid is separated by a centrifugal force. Meanwhile, J P 2022-149429 A discloses a reserve tank in which partition plates having a hole in the lower portion are provided, allowing air mixed in a cooling liquid to be separated while the cooling liquid stays between the partition plates.

### SUMMARY

However, both of the patent documents are intended to separate air mixed in a cooling liquid.

The inventor of the present disclosure has considered that it is effective to suppress mixing of air into a cooling liquid in the first place, rather than separating air mixed in a cooling liquid, in order to suppress a deterioration of the cooling efficiency.

FIG. 6 is a sectional view around a reserve tank a, illustrating a situation in which air (bubbles) c is mixed into a cooling liquid b in the reserve tank a. An inflow portion e formed of a straight pipe is provided at a lower portion of a side wall d of the reserve tank a, and an outflow portion g is provided at a bottom plate f of the reserve tank a. The cooling liquid b flowing into the reserve tank a through the inflow portion e from a cooling liquid circulation circuit (not illustrated) collides with a side wall h (a side wall that faces the side wall d in which the inflow portion e is provided) of the reserve tank a, for example, which directs the flow line upward. As a result, the liquid surface of the cooling liquid b fluctuates (undulates). The fluctuation of the liquid surface is larger as the flow velocity of the cooling liquid b flowing into the reserve tank a is higher. As the liquid surface of the cooling liquid b fluctuates in this manner, air i existing in the upper layer portion in the reserve tank a is entrained in the cooling liquid b, and the air c is mixed into the cooling liquid b. When the air c flows out from the outflow portion g to the cooling liquid circulation circuit and circulates in the cooling liquid circulation circuit, the cooling efficiency deteriorates. Therefore, in order to suppress a deterioration of the cooling efficiency, it is effective to suppress mixing of the air c into the cooling liquid b in the reserve tank a.

The present disclosure has been made in view of the above, and an object thereof is to provide a structure of an inflow portion of a reserve tank capable of suppressing mixing of air into a cooling liquid.

A solution of an aspect of the present disclosure for achieving the above object is premised on a structure of an inflow portion of a reserve tank provided in a cooling liquid circulation circuit. In the structure of an inflow portion of a reserve tank, when a side of the inflow portion closer to a reserve tank body in a flow direction of a cooling liquid is defined as one end side and a side farther from the reserve tank body is defined as another end side, a flow path area of the inflow portion on the one end side is larger than a flow area on the other end side.

According to this specific matter, when the cooling liquid flows into the reserve tank (reserve tank body) through the inflow portion from the cooling liquid circulation circuit, the flow path area of the inflow portion on one end side is larger than the flow path area on the other end side. The other end side is a side farther from the reserve tank body in the flow direction of the cooling liquid. The one end side is a side closer to the reserve tank body in the flow direction of the cooling liquid. As a result, it is possible to reduce the flow velocity of the cooling liquid while suppressing a reduction in the flow rate (the amount of the cooling liquid flowing into the reserve tank body per unit time) at the inflow portion. Therefore, it is possible to suppress the fluctuation of the liquid surface of the cooling liquid in the reserve tank body due to the cooling liquid flowing into the reserve tank body. Thus, it is possible to suppress air existing in the upper layer portion in the reserve tank body being entrained in the cooling liquid so that the air is mixed into the cooling liquid. As a result, the amount of air flowing out to the cooling liquid circulation circuit can be greatly reduced, and a deterioration of the cooling efficiency can be suppressed.

More specifically,

a flow path shape inside the inflow portion may be a tapered shape having a predetermined angle in which a flow path area gradually increases from the other end side toward the one end side.

According to this configuration, it is possible to suppress a rapid change in the flow velocity of the cooling liquid flowing inside the inflow portion. Then, by appropriately defining the predetermined angle of the tapered shape, it is possible to suppress separation of the cooling liquid on the inner surface of the inflow portion. As a result, it is possible to reduce the flow velocity of the cooling liquid flowing inside the inflow portion (it is possible to reduce the flow velocity of the cooling liquid, since it is possible to suppress the occurrence of a dead water region due to separation of the cooling liquid). This also makes it possible to suppress a deterioration of the cooling efficiency by suppressing mixing of air into the cooling liquid in the reserve tank body as described above.

In addition,

a guide vane that divides a flow path for the cooling liquid flowing inside the inflow portion into a plurality of portions may be provided inside the inflow portion.

According to this configuration, the direction of the flow line of the cooling liquid can be changed by the inner surface (e.g. the tapered surface) of the inflow portion and the surface of the guide vane. Therefore, it is possible to increase the inclination angle of the flow path shape while reducing the angle formed between the direction of the flow line of the cooling liquid and the inner surface of the inflow portion or the surface of the guide vane. The inclination angle is the rate of increase in the cross-sectional area inside the inflow portion. Therefore, it is possible to reduce the length of the inflow portion required to reduce the flow velocity of the cooling liquid flowing into the reserve tank body to a predetermined flow velocity while suppressing separation of the cooling liquid. The predetermined flow velocity is a flow velocity at which mixing of air into the cooling liquid in the reserve tank body can be suppressed. Therefore, it is possible to reduce the size of the inflow portion while suppressing mixing of air into the cooling liquid in the reserve tank body.

In addition,

a pressure loss member that applies a pressure loss to the cooling liquid flowing inside the inflow portion may be provided inside the inflow portion.

In this case, the flow velocity of the cooling liquid can be reduced by applying a pressure loss to the cooling liquid flowing inside the inflow portion. Therefore, it is possible to suppress separation of the cooling liquid on the inner surface of the inflow portion, and to increase the inclination angle of the flow path shape. Thus, it is possible to reduce the length of the inflow portion required to reduce the flow velocity of the cooling liquid flowing into the reserve tank body to a predetermined flow velocity while suppressing separation of the cooling liquid. This also makes it possible to reduce the size of the inflow portion while suppressing mixing of air into the cooling liquid in the reserve tank body.

In addition,

the one end side of the inflow portion may be open in a direction intersecting a side wall of the reserve tank body, and the other end side of the inflow portion may be open in a direction along an extension direction of the side wall of the reserve tank body.

According to this configuration, the flow velocity of the cooling liquid flowing into the inflow portion from the other end side reduces while the cooling liquid is flowing in the direction along the extension direction of the side wall of the reserve tank body. That is, the length of the inflow portion in the direction intersecting the side wall of the reserve tank body can be reduced as compared with the case where the flow velocity reduces while the cooling liquid is flowing in the direction intersecting the side wall of the reserve tank body. This also makes it possible to reduce the size of the inflow portion while suppressing mixing of air into the cooling liquid in the reserve tank body.

In the present disclosure, the flow path area of the inflow portion of the reserve tank on the one end side, which is the side closer to the reserve tank body, is larger than the flow path area on the other end side, which is the side farther from the reserve tank body. Therefore, it is possible to reduce the flow velocity of the cooling liquid while suppressing a reduction in the flow rate at the inflow portion. Thus, it is possible to suppress air existing in the upper layer portion in the reserve tank body being entrained in the cooling liquid so that the air is mixed into the cooling liquid. As a result, the amount of air flowing out to the cooling liquid circulation circuit can be greatly reduced, and a deterioration of the cooling efficiency can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a cooling liquid circulation circuit provided with a reserve tank according to an embodiment;

FIG. 2 is a cross-sectional view around a reserve tank according to the embodiment;

FIG. 3 is an enlarged cross-sectional view of an inflow portion of the reserve tank according to the embodiment;

FIG. 4A is a view showing an inflow portion of a reserve tank according to a first modification, and is a cross-sectional view showing an inflow portion in an enlarged form;

FIG. 4B is a view showing an inflow portion of a reserve tank according to a first modification, showing a cross-sectional view in a direction perpendicular to a flow line when a flow velocity reduction portion of an inflow portion is made to be a truncated cone shape;

FIG. 4C is a view showing an inflow portion of a reserve tank according to a first modification, and is a cross-sectional view in a direction perpendicular to a flow line when a flow velocity reduction portion of an inflow portion is made to be a truncated quadrangular pyramid shape;

FIG. 5A is a side view illustrating an inflow portion of a reserve tank according to a second modification;

FIG. 5B is a perspective view illustrating an inflow portion of a reserve tank according to a third modification;

FIG. 5C is a perspective view illustrating an inflow portion of a reserve tank according to a fourth modification; and

FIG. 6 is a cross-sectional view around a reserve tank for explaining a state in which air is mixed into a cooling liquid in the reserve tank in the prior art.

### DETAILED DESCRIPTION OF EMBODIMENTS

Hereinafter, an embodiment of the present disclosure will be described with reference to the drawings. The present embodiment will be described with reference to a configuration in which the present disclosure is applied as a configuration of an inflow portion of a reserve tank provided in a cooling liquid circulation circuit in a battery cooling system of a battery electric vehicle. The cooling liquid circulation circuit to which the present disclosure is applicable is not limited to the cooling liquid circulation circuit in the battery cooling system of battery electric vehicle. Examples of the cooling liquid circulation circuit to which the present disclosure is applicable include cooling liquid circulation circuits in various cooling systems such as a cooling system of an inverter, a cooling system of an electric motor, and an engine cooling system in an engine-mounted vehicle.

### Schematic Configuration of the Cooling Liquid Circulation Circuit

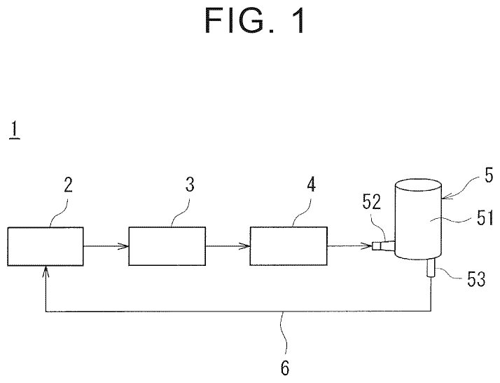

FIG. 1 is a diagram illustrating a schematic configuration of a cooling liquid circulation circuit 1 provided with a reserve tank 5 according to the present embodiment. As shown in FIG. 1, in the cooling liquid circulation circuit 1, a pump 2, a heat exchanger 3, a battery (for example, a cooling liquid flow path provided inside a battery) 4 that is a device to be cooled, and a reserve tank 5 are connected by a pipe 6 so that the cooling liquid can be circulated.

The pump 2 is made of, for example, an electric type, and circulates the cooling liquid to the cooling liquid circulation circuit 1 by being operated.

The heat exchanger 3 exchanges heat between the cooling liquid circulating in the cooling liquid circulation circuit 1 and the outside air, releases the heat of the cooling liquid to the outside air, and thereby cools the cooling liquid. The medium for performing heat exchange with the cooling liquid is not limited to outside air.

The battery 4 stores electric power for supplying power to a traveling motor, which is a traveling driving force source of battery electric vehicle, or another electric device. The battery 4 generates heat with charging and discharging. In recent battery electric vehicle, the energy density of the battery 4 tends to be increased in order to increase the traveling performance of the vehicles or to increase the traveling range. Therefore, efficient cooling of the battery 4 is required. Therefore, it is required to reduce the amount of air in the cooling liquid circulation circuit 1 to suppress deterioration in cooling efficiency.

The reserve tank 5 includes a reserve tank body 51 formed of a substantially cylindrical container for storing a cooling liquid. The reserve tank body 51 is connected to a pipe (a pipe extending from the battery 4) 6 via an inflow portion 52. The reserve tank body 51 is connected to a pipe (a pipe extending to the suction side of the pump 2) 6 via an outflow portion 53. The reserve tank 5 has a function of absorbing a volume change caused by thermal expansion of the cooling liquid. The reserve tank 5 is used to replenish the cooling liquid circulation circuit 1 with cooling liquid.

### Configuration of the Reserve Tank

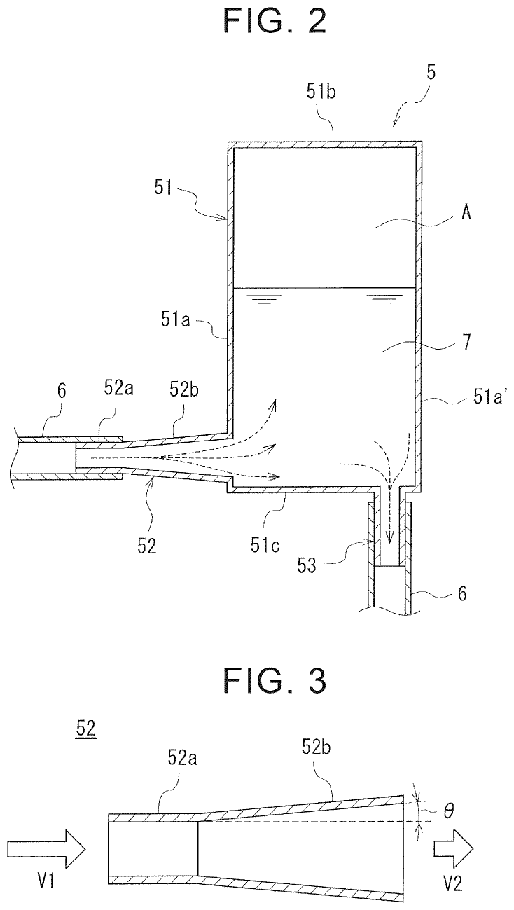

Next, the configuration of the reserve tank 5 will be described. FIG. 2 is a cross-sectional view around the reserve tank 5 according to the present embodiment. As shown in FIG. 2, the reserve tank 5 has a configuration including a reserve tank body 51, an inflow portion 52 integrally connected to the reserve tank body 51, and an outflow portion 53.

The reserve tank body 51 is a substantially cylindrical container and includes a side wall 51a, a top plate 51b, and a bottom plate 51c. A predetermined amount of cooling liquid 7 is stored in the reserve tank body 51. When the cooling liquid 7 stored in the reserve tank body 51 is reduced to a predetermined amount (when the liquid level of the cooling liquid 7 is lowered to a predetermined position), the cooling liquid 7 is replenished from the top plate 51b of the reserve tank body 51. A configuration for replenishment is well known, and therefore, illustration thereof is omitted. Note that the reserve tank body 51 is not limited to a substantially cylindrical container, and may be a rectangular cylindrical container.

An inflow portion 52 is integrally connected to a lower portion of one side wall (a side wall located on the left side in FIG. 2) 51a of the reserve tank body 51. Further, in the bottom plate 51c of the reserve tank body 51, an outflow portion 53 is integrally connected to a position on the side wall 51a′ opposite to the side wall 51a to which the inflow portion 52 is connected. The side wall facing away from the side wall 51a is a side wall (side wall located on the right side in FIG. 2) 51a′ facing the side wall 51a.

### Inflow Portion Structure

Next, the structure of the inflow portion 52, which is a feature of the present embodiment, will be described. FIG. 3 is an enlarged sectional view of the inflow portion 52. As shown in FIG. 3, the inflow portion 52 includes a straight pipe portion 52a and a flow velocity reduction portion 52b. The straight pipe portion 52a is a portion connected to the pipe 6 of the cooling liquid circulation circuit 1, and the flow rate reduction portion 52b is a portion connected to the side wall 51a of the reserve tank body 51.

The straight pipe portion 52a is formed of a straight tube whose inner diameter dimension is uniform over the entire longitudinal direction. The outer diameter of the straight pipe portion 52a substantially matches the inner diameter of the pipe 6, as shown in FIG. 2, by the straight pipe portion 52a is inserted into the inside of the pipe 6, the pipe 6 and the inflow portion 52 is connected. Conversely, the pipe 6 may be inserted into the straight pipe portion 52a, so that the pipe 6 and the inflow portion 52 are connected to each other. In the present embodiment, the inner diameter and the outer diameter of the straight pipe portion 52a substantially coincide with the inner diameter and the outer diameter of the outflow portion 53 formed of a straight pipe, respectively.

A side close to the reserve tank body 51 (a side connected to the reserve tank body 51) in the flow velocity reduction portion 52b is defined as one end side of the flow velocity reduction portion 52b. The other end side of the flow velocity reduction portion 52b is defined as a side farther from the reserve tank body 51 (the side connected to the straight pipe portion 52a) in the flow velocity reduction portion 52b. In this configuration, the flow velocity reduction portion 52b has a larger flow path area on one end side than the flow path area on the other end side. More specifically, the flow path shape inside the flow velocity reduction portion 52b has a tapered shape in which the flow path area gradually increases from the other end side toward the one end side.

As described above, the flow passage area on one end side is larger than the flow passage area on the other end side of the flow velocity reduction portion 52b. Consequently, the flow rate of the cooling liquid 7 decreases while suppressing the flow rate of the cooling liquid (the cooling liquid 7 in the flow rate V1 in FIG. 3) flowing from the pipe 6 into the inflow portion 52 from decreasing in the inflow portion 52. That is, the flow velocity V2 (<V1) in FIG. 3 is obtained. The flow rate in the inflow portion 52 is the amount of the cooling liquid 7 flowing into the reserve tank body 51 per unit time.

More specifically, an inclination angle (opening angle) θ of the tapered shape is set to be less than 5° as a flow path shape inside the flow velocity reduction portion 52b. This is to suppress the peeling of the cooling liquid 7 on the inner surface of the inflow portion 52 when the inclination angle θ of the tapered shape is too large. That is, when the cooling liquid 7 is peeled off on the inner surface of the inflow portion 52, a dead water region is generated due to the peeling, and there is a possibility that the flow velocity of the cooling liquid 7 cannot be lowered. In view of this, as described above, the inclination angle of the tapered shape is defined, and the separation of the cooling liquid 7 on the inner surface of the inflow portion 52 is suppressed, and the generation of the dead water region is suppressed, so that the flow velocity of the cooling liquid 7 can be lowered.

The flow velocity reduction portion 52b has such a configuration. Therefore, in order to reduce the flow rate of the cooling liquid 7 to a predetermined flow rate while the tapered inclination angle θ is set as described above, the length dimension of the flow rate reduction portion 52b needs to be increased as the ratio C=A2/A1 is increased. A1 is a cross-sectional area of the other end side of the flow velocity reduction portion 52b (the end portion on the upstream side in the flow direction of the cooling liquid 7). A2 is a cross-sectional area of one end of the flow velocity reduction portion 52b (an end portion downstream in the flow direction of the cooling liquid 7).

### Cooling Liquid Inflow Condition

Next, an inflow state of the cooling liquid 7 into the reserve tank body 51 by having the inflow portion 52 configured as described above will be described. A broken arrow in FIG. 2 indicates the flow of the cooling liquid 7 flowing into the reserve tank body 51 and the cooling liquid 7 flowing out of the reserve tank body 51 to the cooling liquid circulation circuit 1.

The cooling liquid 7 flowing into the inflow portion 52 from the pipe 6 of the cooling liquid circulation circuit 1 passes through the straight pipe portion 52a and then flows through the flow velocity reduction portion 52b. The flow path shape inside the flow velocity reduction portion 52b has a tapered shape in which the flow path area gradually increases toward the flow direction of the cooling liquid 7. Therefore, the flow rate of the cooling liquid 7 in the inflow portion 52 (the amount of the cooling liquid 7 flowing into the reserve tank body 51 per unit time) is suppressed from decreasing, but the flow rate of the cooling liquid 7 decreases. Therefore, the flow rate of the cooling liquid 7 flowing into the reserve tank body 51 also decreases.

In the prior art, a flow line is directed upward by, for example, a cooling liquid (a cooling liquid having a relatively high flow rate) flowing into the reserve tank body collides with a side wall of the reserve tank body (a side wall opposed to a side wall in which the inflow portion is provided). As a result, there is a high possibility that the air existing in the upper layer portion in the reserve tank body is caught in the cooling liquid due to the fluctuation of the liquid level of the cooling liquid. Therefore, the air flows out from the outflow portion to the cooling liquid circulation circuit, resulting in deterioration of the cooling efficiency.

On the other hand, in the present embodiment, since the flow rate of the cooling liquid 7 flowing into the reserve tank body 51 is reduced, the liquid level of the cooling liquid 7 is suppressed from fluctuating. Accordingly, it is possible to prevent the air A existing in the upper layer portion in the reserve tank body 51 from being caught in the cooling liquid 7. Therefore, the amount of air flowing out to the cooling liquid circulation circuit 1 can be greatly reduced, and deterioration in cooling efficiency can be suppressed.

### Effects of Embodiment

As described above, in the present embodiment, the flow path area on the one end side, which is the side close to the reserve tank body 51, is made larger than the flow path area on the other end side, which is the side far from the reserve tank body 51, in the inflow portion 52 of the reserve tank 5. Therefore, it is possible to reduce the flow rate of the cooling liquid 7 while suppressing the flow rate in the inflow portion 52 from decreasing. As a result, it is possible to prevent air A existing in the upper layer portion in the reserve tank body 51 from being entrained in the cooling liquid 7 and air from being mixed into the cooling liquid 7. As a result, the amount of air flowing out to the cooling liquid circulation circuit 1 can be greatly reduced, and deterioration in cooling efficiency can be suppressed. Since the deterioration of the cooling efficiency can be suppressed in this way, the battery 4 can be efficiently cooled, which contributes to the improvement of the energy consumption rate (electric power cost).

Incidentally, the inventor of the present disclosure calculated the amount of air flowing out from the outflow portion 53 (the amount of air flowing out to the cooling liquid circulation circuit 1) by numerical analysis. Specifically, the ratio of the cross-sectional area of the downstream end to the upstream end of the inflow portion is set to 1, and the ratio of the cross-sectional area of the downstream end to the upstream end of the inflow portion 52 is set to 2 as the present disclosure. As a result, in the reserve tank 5 according to the present disclosure as compared with the reserve tank of the prior art, it was confirmed that the amount of air flowing out of the outflow portion 53 is reduced by about 50%. Thus, it was confirmed that deterioration in cooling efficiency can be suppressed.

### First Modification

Next, a first modification will be described. This modification differs from the above-described embodiment in the configuration of the flow velocity reduction portion 52b, in particular, the configuration of the inside of the flow velocity reduction portion 52b. Since other configurations are the same as those of the above-described embodiment, only differences from the above-described embodiment will be described here.

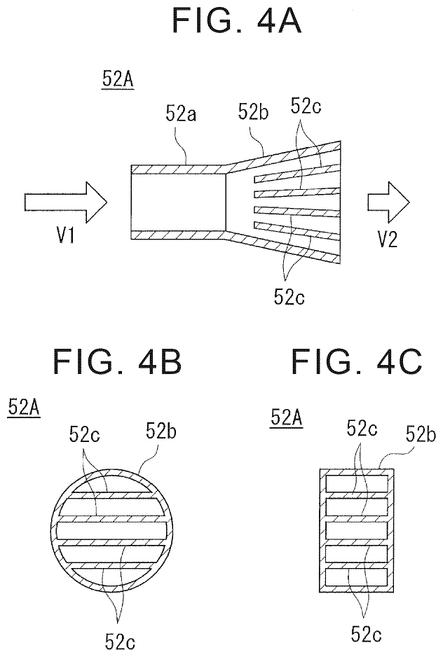

FIG. 4A to FIG. 4C are diagrams illustrating an inflow portion 52A of the reserve tank 5 according to the present modification. FIG. 4A is a cross-sectional view showing an enlarged inflow portion 52A. FIG. 4B is a cross-sectional view of the flow velocity reduction portion 52b of the inflow portion 52A in a direction perpendicular to the flow line in a truncated conical shape.

As shown in these figures, the flow velocity reduction portion 52b according to the present modification is provided with a plurality of guide vanes 52c, 52c, . . . that divide the flow path of the cooling liquid 7 flowing therein into a plurality. The guide vane 52c extend horizontally as shown in FIG. 4B and are connected at both ends to the inner surface of the flow velocity reduction portion 52b. As a result, a plurality of flow paths that are independent of each other are formed in the flow velocity reduction portion 52b in the vertical direction. In addition, the inclination angle (inclination angle with respect to the horizontal direction) of the guide vane 52c, 52c, . . . increases with 52c of the guide vanes positioned on the outer side (positioned on the outer side in the vertical direction). More specifically, the inclination angles of the guide vanes 52c, 52c, . . . are arranged such that the angles formed between the wall surfaces adjacent to each other (the inner surface of the flow velocity reduction portion 52b and the wall surface of the adjacent guide vane 52c) are less than a predetermined angle (for example 5°).

In this way, when the guide vanes 52c, 52c, . . . are provided inside the flow velocity reduction portion 52b, the flow line of the cooling liquid 7 can be changed (slightly changed outward) by the inner surface of the flow velocity reduction portion 52b or the surface of the guide vane 52c. The inner surface of the flow velocity reduction portion 52b is, for example, a tapered surface. As a result, the inclination angle of the flow path can be increased while the angle formed between the direction of the flow line of the cooling liquid 7 and the inner surface of the flow velocity reduction portion 52b or the surface of the guide vane 52c is reduced. The slope angle of the flow path shape is an enlargement ratio of a cross-sectional area of the inside of the flow velocity reduction portion 52b. Therefore, the length of the inflow portion 52A required to reduce the flow rate of the cooling liquid 7 flowing into the reserve tank body 51 to a predetermined flow rate can be shortened while suppressing the separation of the cooling liquid 7. The predetermined flow rate is a flow rate at which air can be prevented from being mixed into the cooling liquid 7 in the reserve tank body 51. Therefore, it is possible to reduce the size of the inflow portion 52A while preventing the cooling liquid 7 from being entrained in the reserve tank body 51.

Incidentally, FIG. 4C is a cross-sectional view in a direction perpendicular to the flow line when the flow velocity reduction portion 52b of the inflow portion 52A is a quadrangular pyramid shape. Even in the case shown in FIG. 4C, a plurality of guide vanes 52c, 52c, . . . are provided inside the flow velocity reduction portion 52b. Even in this configuration, as described above, the length of the inflow portion 52A required to reduce the flow rate of the cooling liquid 7 flowing into the reserve tank body 51 to a predetermined flow rate can be shortened while suppressing the separation of the cooling liquid 7. Therefore, it is possible to reduce the size of the inflow portion 52A while preventing the cooling liquid 7 from being entrained in the reserve tank body 51.

### Second Modification

Next, a second modification will be described. This modification also differs from the above-described embodiment in the configuration of the flow velocity reduction portion 52b. Since other configurations are the same as those of the above-described embodiment, only differences from the above-described embodiment will be described here.

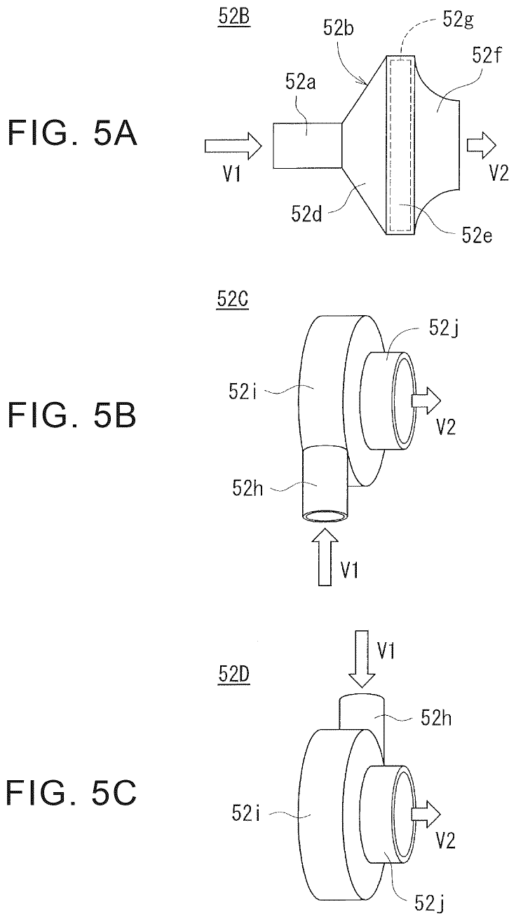

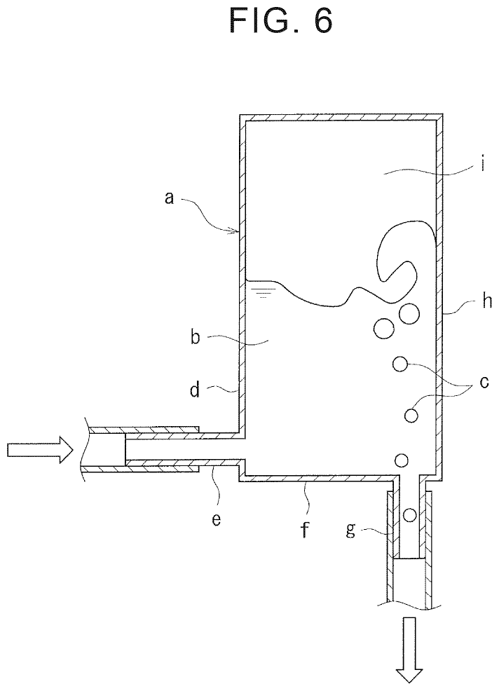

FIG. 5A is a side view showing an inflow portion 52B of a reserve tank 5 according to the present modification. As shown in FIG. 5A, in the flow velocity reduction portion 52b of the inflow portion 52B according to the present modification, the enlarged diameter portion 52d, the cylindrical portion 52e, and the reduced diameter portion 52f are integrally disposed along the flow direction of the cooling liquid 7.

The enlarged-diameter portion 52d has a tapered shape in which the channel area gradually increases from the other end side toward the one end side. For this reason, the upstream side (the left side in FIG. 5A) of the enlarged diameter portion 52d in the cooling liquid flow direction is an example of the “other end side which is a side far from the reserve tank body” in the present disclosure. A downstream side (right side in FIG. 5A) of the enlarged-diameter portion 52d in the cooling liquid flow direction is an example of “one end side which is a side close to the reserve tank body” in the present disclosure.

In addition, a pressure loss member 52g (indicated by a broken line in FIG. 5A) made of a mesh material, a porous material, or the like is accommodated in the cylindrical portion 52e. The pressure loss member 52g has a cylindrical shape that substantially matches the shape of the inside of the cylindrical portion 52e. Thus, when the cooling liquid 7 passes through the inside of the cylindrical portion 52e, a pressure-loss is added to the cooling liquid 7. For this reason, the flow velocity of the cooling liquid 7 flowing into the inflow portion 52B is reduced at the enlarged diameter portion 52d, and therefore, the cooling liquid is hardly peeled off. Therefore, as the flow path configuration inside the enlarged diameter portion 52d, the inclination angle can be increased, and even when the inclination angle is set to 5° or more, peeling is less likely to occur. Therefore, the length of the inflow portion 52B required to reduce the flow rate of the cooling liquid 7 flowing into the reserve tank body 51 to a predetermined flow rate can be shortened while suppressing the separation of the cooling liquid 7. As a result, it is possible to reduce the size of the inflow portion 52B while preventing the cooling liquid 7 from being entrained in the reserve tank body 51.

The reason why the reduced-diameter portion 52f is provided downstream of the cylindrical portion 52e is to allow the flow of the cooling liquid 7 to flow into the reserve tank body 51 while rectifying the flow. This is because, when the cooling liquid 7 flows through the cylindrical portion 52e, there is a possibility that the velocity profile of the cooling liquid 7 may be disturbed by passing through the pressure loss member 52g.

### Third Modification

Next, a third modification will be described. This modification differs from the embodiment described above in the overall configuration of the inflow portion 52. Since other configurations are the same as those of the above-described embodiment, only differences from the above-described embodiment will be described here.

FIG. 5B is a perspective view showing an inflow portion 52C of a reserve tank 5 according to the present modification. As shown in FIG. 5B, in the inflow portion 52C according to the present modification, the upstream-side straight pipe portion 52h, the cylindrical portion 52i, and the downstream-side straight pipe portion 52j are integrally disposed.

The upstream-side straight pipe portion 52h extends in a direction along the up-down direction (extending direction of the side wall 51a of the reserve tank body 51). Further, the upstream straight-pipe portion 52h is open at the upstream end side in the flow direction of the cooling liquid 7 downward, and the open portion is connected to the pipe 6.

The cylindrical portion 52i is formed in a cylindrical shape having a horizontal direction (a direction intersecting the side wall 51a of the reserve tank body 51) as a center line direction. Then, with respect to the cylindrical portion 52i, the upstream-side straight pipe portion 52h is connected from the tangential lower side of the outer peripheral surface of the cylindrical portion 52i. Therefore, when the cooling liquid 7 flows into the cylindrical portion 52i from the upstream-side straight pipe portion 52h, the cooling liquid 7 becomes a swirling flow along the inner peripheral surface of the cylindrical portion 52i and flows inside the cylindrical portion 52i. The flow velocity of the cooling liquid 7 is reduced because the inner area of the cylindrical portion 52i (the area in the direction perpendicular to the direction of the flow line of the swirling flow) is larger than the flow passage area of the upstream-side straight pipe portion 52h. Therefore, a part of the cylindrical portion 52i to which the upstream-side straight pipe portion 52h is connected is an exemplary “other end side which is a side far from the reserve tank body” in the present disclosure. A downstream-side part of the inner space of the cylindrical portion 52i in the flow direction of the cooling liquid 7 is an example of “one end side which is a side close to the reserve tank body” in the present disclosure.

Further, the downstream-side straight pipe portion 52j is connected to a central portion of a side wall facing the reserve tank body 51 in the cylindrical portion 52i. The opening direction of the downstream-side straight pipe portion 52j is a horizontal direction (a direction intersecting the side wall 51a of the reserve tank body 51). This open part is connected to the side wall 51a of the reserve tank body 51. Further, the inner diameter dimension of the downstream-side straight pipe portion 52j is set larger than the inner diameter dimension of the upstream-side straight pipe portion 52h, when the cooling liquid 7 flows inside the downstream-side straight pipe portion 52j, so that the flow rate of the cooling liquid 7 does not become too high.

In the present modification, the flow velocity of the cooling liquid 7 flowing into the inflow portion 52C decreases while flowing in a direction along the extension direction of the side wall 51a of the reserve tank body 51. That is, the length of the inflow portion 52C in the direction intersecting with the side wall 51a of the reserve tank body 51 can be shortened as compared with the case where the flow velocity decreases while flowing in the direction intersecting with the side wall 51a of the reserve tank body 51. As a result, it is possible to reduce the size of the inflow portion 52C while preventing the cooling liquid 7 from being entrained in the reserve tank body 51.

### Fourth Modification

Next, a fourth modification will be described. In this modification, the configuration of the upstream-side straight pipe portion 52h is different from that of the third modification described above. Since other configurations are the same as those of the third modification example, only differences from the third modification example will be described here.

FIG. 5C is a perspective view showing an inflow portion 52D of a reserve tank 5 according to the present modification. As shown in FIG. 5C, in the inflow portion 52D according to the present modification, the upstream-side straight pipe portion 52h, the cylindrical portion 52i, and the downstream-side straight pipe portion 52j are integrally disposed. The configuration of the cylindrical portion 52i and the downstream-side straight-pipe portion 52j is the same as that of the third modification described above.

The upstream-side straight pipe portion 52h extends in a direction along the up-down direction (extending direction of the side wall 51a of the reserve tank body 51). Further, the upstream-side straight pipe portion 52h is open at the upstream end side in the flow direction of the cooling liquid 7 upward, and the open portion is connected to the pipe 6. Then, with respect to the cylindrical portion 52i, the upstream-side straight pipe portion 52h is connected from the tangential upper side of the outer peripheral surface of the cylindrical portion 52i.

Even in the present modification, the flow velocity of the cooling liquid 7 flowing into the inflow portion 52D decreases while flowing in a direction along the extension direction of the side wall 51a of the reserve tank body 51. That is, the length of the inflow portion 52D in the direction intersecting with the side wall 51a of the reserve tank body 51 can be shortened as compared with the case where the flow velocity decreases while flowing in the direction intersecting with the side wall 51a of the reserve tank body 51. As a result, it is possible to reduce the size of the inflow portion 52C while preventing the cooling liquid 7 from being entrained in the reserve tank body 51.

Further, in the configurations of the third modification and the fourth modification described above, since the opening direction of the upstream-side straight pipe portion 52h can be arbitrarily set, the degree of freedom of mounting of the reserve tank 5 with respect to the vehicle can be increased.

### OTHER EMBODIMENTS

It should be noted that the present disclosure is not limited to the above-described embodiments and the above-described modification examples, and all modifications and applications encompassed within the scope of the claims and the scope of equivalents thereof are possible.

For example, in the above-described embodiment and the above-described modifications, the reserve tank body 51, the inflow portion 52 (52A, 52B, 52C, 52D), and the outflow portion 53 are integrally molded to form the reserve tank 5. The present disclosure is not limited thereto. The reserve tank body 51, the inflow portion 52 (52A, 52B, 52C, 52D), and the outflow portion 53 may be separately formed, and the reserve tank 5 may be configured by integrally assembling them.

Further, in the above-described embodiment and the above-described first modification, the shape of the flow velocity reduction portion 52b is a tapered shape. The tapered shape is a tapered shape in which the flow passage area gradually increases from the other end side toward the one end side over the entire circumference. The other end side is a side far from the reserve tank body 51 in the flow direction of the cooling liquid 7. The one end side is a side close to the reserve tank body 51 in the flow direction of the cooling liquid 7. The present disclosure is not limited thereto, and may be configured such that a portion of the periphery of the flow velocity reduction portion 52b is inclined from the other end side toward the one end side, so that the flow path area gradually increases. For example, only the upper part of the flow velocity reduction portion 52b may be enlarged upward. In addition, as the flow path shape inside the inflow portion 52, it is sufficient that the flow path area on the one end side is larger than the flow path area on the other end side, and it is not necessarily required to have a tapered shape. For example, the inner surface of the inflow portion 52 may have a stepped shape, and the flow passage area on the one end side may be larger than the flow passage area on the other end side.

The present disclosure is applicable to a configuration of an inflow portion of a reserve tank provided in a cooling liquid circulation circuit in a battery cooling system of a battery electric vehicle.

What is claimed is:

1. A structure of an inflow portion of a reserve tank provided in a cooling liquid circulation circuit, wherein, when a side of the inflow portion closer to a reserve tank body in a flow direction of a cooling liquid is defined as one end side and a side farther from the reserve tank body is defined as another end side, a flow path area of the inflow portion on the one end side is larger than a flow area on the other end side.

2. The structure according to claim 1, wherein a flow path shape inside the inflow portion is a tapered shape having a predetermined angle in which a flow path area gradually increases from the other end side toward the one end side.

3. The structure according to claim 1, wherein a guide vane that divides a flow path for the cooling liquid flowing inside the inflow portion into a plurality of portions is provided inside the inflow portion.

4. The structure according to claim 1, wherein a pressure loss member that applies a pressure loss to the cooling liquid flowing inside the inflow portion is provided inside the inflow portion.

5. The structure according to claim 1, wherein the one end side of the inflow portion is open in a direction intersecting a side wall of the reserve tank body, and the other end side of the inflow portion is open in a direction along an extension direction of the side wall of the reserve tank body.
